(19) United States
(12) Patent Application Publication
(10) Pub. No.: US 2011/0310360 A1
(43) Pub. Date: Dec. 22, 2011

(54) ADJUSTING SYSTEM AND PROJECTOR INCLUDING SAME

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/843,032

(22) Filed: Jul. 25, 2010

(30) Foreign Application Priority Data
Jun. 18, 2010 (TW) 99120032

(51) Int. Cl. G03B 21/14

(52) U.S. Cl. 353/70

(57) ABSTRACT

A projector includes a body, a support shaft, an input unit, a distance detection unit mounted on a front surface of the body, an angle detection unit mounted in the support shaft, a micro controller unit, a graphics processing unit (GPU), and an optical unit. The distance detection unit detects a distance between the distance detection unit and a light point on a screen by the distance detection unit. The angle detection unit detects a projection angle of the body. The MCU obtains a correction value according to the distance between the distance detection unit and the light point on the screen, and the projection angle of the body. The GPU corrects the images from the input unit according to the correction value. The optical unit projects the corrected images on the screen.

### BACKGROUND

1. Technical Field

The present disclosure relates to projectors, and particularly, to a projector including an adjusting system.

2. Description of Related Art

Projectors are widely used in a lot of places, such as offices, homes, etc. Sometimes, users need to make manual adjustments to the projection angle of a projector to make the projected image align with the screen. However, when the projection angle is raised too much, the image on the screen may become a trapezoid shape. As a result, the image parameters need to be adjusted in the menu of the projector or by pressing other buttons on the projector, which is inconvenient and time-consuming.

### BRIEF DESCRIPTION OF THE DRAWINGS

FIG. 1 is an isometric view of an exemplary embodiment of a projector.

FIG. 2 is a block diagram of the projector including an angle detection unit.

FIG. 3 is a schematic diagram of the angle detection unit of FIG. 2.

FIG. 4 is a diagram showing how to obtain a correction value according to a projection distance and a projection angle.

### DETAILED DESCRIPTION

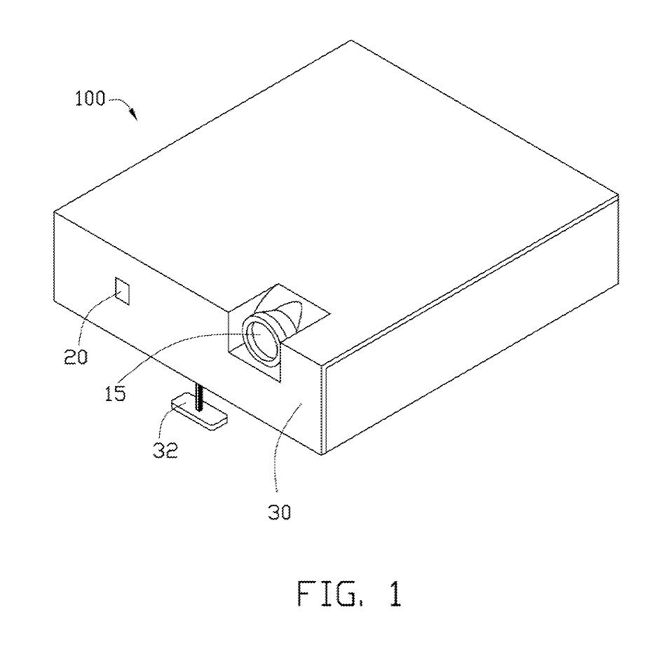

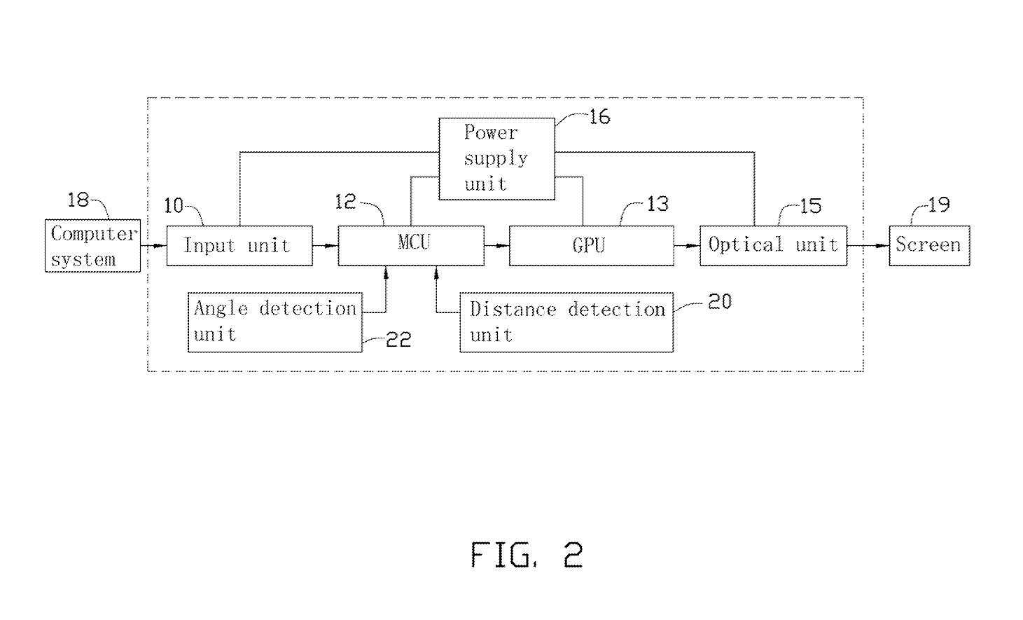

Referring to FIGS. 1 and 2, an embodiment of a projector 100 includes a body 30, a support shaft 32, an input unit 10, a micro controller unit (MCU) 12, a graphics processing unit (GPU) 13, an optical unit 15, a distance detection unit 20, an angle detection unit 22, and a power supply unit 16. The MCU 12, the distance detection unit 20, and the angle detection unit 22 compose an adjusting system for the projector 100.

In the embodiment, the input unit 10, the MCU 12, the GPU 13, the optical unit 15, and the power supply unit 16 are located inside the body 30 of the projector 100. The distance detection unit 20 is mounted on a front surface of the body 30. The angle detection unit 22 is mounted in the support shaft 32 of the projector 100.

In use, the user connects a computer system 18 to the input unit 10 of the projector 100, for transmitting images stored in the computer system 18 to the projector 100. The images are processed by the MCU 12, the GPU 13, and then projected on a screen 19 by the optical unit 15. The power supply unit 16 provides power for the MCU 12, the GPU 13, the distance detection unit 20, and the angle detection unit 22. In addition, the projector 100 includes other units, such as heat dissipation unit.

The distance detection unit 20 detects a distance between the distance detection unit 20 and a light point formed on the screen 19 by the distance detection unit 20. In the embodiment, the distance detection unit 20 is an infrared telemeter. The distance between the infrared telemeter and the light point formed on the screen 19 can be calculated by the time delay between the infrared telemeter emitting and receiving the infrared signal, and the speed of the infrared signal. The distance can be regarded as a projection distance. The distance detection unit 20 is connected to the MCU 12, for transmitting the projection distance to the MCU 12.

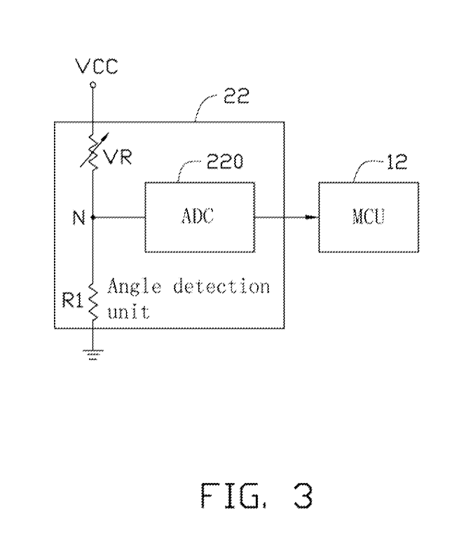

The angle detection unit 22 detects changes in projection angles of the body 30. Referring to FIG. 3, the angle detection unit 22 includes a rheostat VR, a resistor R1, and an analog-to-digital converter (ADC) 220. A slide terminal of the rheostat VR is connected to the support shaft 32 of the projector 100. A first terminal of the rheostat VR is connected to a first power supply VCC. A second terminal of the rheostat VR is grounded through the resistor R1. A node N between the rheostat VR and the resistor R1 is connected to an input of the ADC 220. An output of the ADC 220 is connected to the MCU 12.

When the support shaft 32 is adjusted, the slide terminal of the rheostat VR slides to change the resistance of the bottom portion of the rheostat VR. According to FIG. 3, Va=Vcc*R1/(VRa+R1), wherein Va denotes the voltage at the node N, and VRa denotes the resistance of the bottom portion of the rheostat VR. When the resistance of the bottom portion of the rheostat VR changes, the voltage at the node N changes. As a result, the projection angle of the body 30 can be obtained according to the output of the ADC 220, and then is transmitted to the MCU 12. The relationship between the VRa, R1, and the projection angle of the body 30 is shown as table 1:

TABLE 1

| Projection angle | VRa | | |
|---|---|---|---|
| (degrees) | (Ω) | Va (V) | Output of the ADC |
| 0 | VR1 | Vcc * R1/(VR1 + R1) | 000 |
| 5 | VR2 | Vcc * R1/(VR2 + R1) | 001 |
| 10 | VR3 | Vcc * R1/(VR3 + R1) | 010 |
| 15 | VR4 | Vcc * R1/(VR4 + R1) | 011 |
| 20 | VR5 | Vcc * R1/(VR5 + R1) | 100 |
| 25 | VR6 | Vcc * R1/(VR6 + R1) | 101 |
| 30 | VR7 | Vcc * R1/(VR7 + R1) | 110 |
| 35 | VR8 | Vcc * R1/(VR8 + R1) | 111 |

From the table 1, the projection angle of the body 30 can be obtained according to the output of the ADC 220. For example, when the output of the ADC 220 is “110”, the projection angle of the body 30 is 30 degrees. The relationship between the VRa, R1, and the projection angle of the body 30 may be established in advance.

After the MCU 12 receives the projection distance and the projection angle of the body 30, the MCU 12 obtains a throw distance between the distance detection unit 20 and the screen 19 according to the projection distance and the projection angle of the body 30. The throw distance herein is the vertical distance between the projector 100 and the screen 19. The MCU 12 further obtains a correction value according to the throw distance and the projection angle of the body 30, and transmits the correction value to the GPU 13. The GPU 13 corrects the images from the computer system 18 according to the correction value. The corrected images are projected to the screen 19 by the optical unit 15.

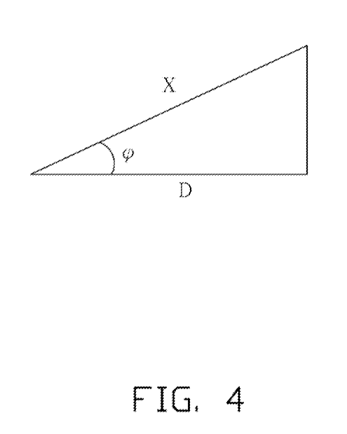

Referring to FIG. 4, D denotes the throw distance between the distance detection unit 20 and the screen 19, X denotes the distance between the distance detection unit 20 and the light point formed on the screen 19 (namely the projection distance) when the projector 100 is raised up to a certain angle φ. It can be obtained from the FIG. 3 that D=Xcos φ.

When the certain angle φ is equal to 0 degrees, the throw distance between the distance detection unit 20 and the screen 19 is equal to the distance between the distance detection unit 20 and the light point formed on the screen 19. At this time, the images projected on the screen 19 do not form a trapezoid shape.

When the certain angle φ is not equal to 0 degrees, the throw distance between the distance detection unit 20 and the screen 19 is shorter than the distance between the distance detection unit 20 and the light point formed on the screen 19. At this time, the image projected on the screen 19 forms a trapezoid shape. As a result, it is determined that a difference between the throw distance between the distance detection unit 20 and the screen 19, and the distance between the distance detection unit 20 and the light point formed on the screen 19 corresponds to the distortion of the image projected on the screen 19. The MCU 12 calculates the correction value according to the difference between the throw distance between the distance detection unit 20 and the screen 19, and the distance between the distance detection unit 20 and the light point formed on the screen 19. The GPU 13 processes the image according to the correction value. For example, the GPU 13 adjusts a bottom width of the image from the computer system 18, and then projects the corrected image to the screen 19 by the optical unit 15. In the embodiment, the GPU 13 may make adjustments according to the correction value.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. An adjusting system for a projector, the adjusting system comprising:
a distance detection unit mounted on a front surface of the projector, for detecting a distance between the distance detection unit and a light point on a screen;
an angle detection unit mounted on a support shaft of the projector, for detecting a projection angle of the projector;
a micro controller unit (MCU) for processing the distance from the distance detection unit and the projection angle from the angle detection unit to obtain a correction value; and
a graphics processing unit (GPU) to correct images inputted to the projector according to the correction value.

2. The adjusting system of claim 1, wherein the MCU processes the distance between the distance detection unit and the light point on the screen, and the projection angle of the projector to obtain a throw distance between the distance detection unit and the screen, the MCU further processes the throw distance and the projection angle of the projector to obtain the correction value.

3. The adjusting system of claim 2, wherein the distance detection unit is an infrared telemeter.

4. The adjusting system of claim 2, wherein the throw distance between the distance detection unit and the screen equals to a product of the distance between the distance detection unit and the light point on the screen and a cosine of the projection angle of the projector.

5. The adjusting system of claim 1, wherein the angle detection unit includes a rheostat, a resistor, and an analog-to-digital converter (ADC), a slide terminal of the rheostat is connected to the support shaft of the projector, a first terminal of the rheostat is connected to a first power supply, a second terminal of the rheostat is grounded through the resistor, a node between the rheostat and the resistor is connected to an input of the ADC, an output of the ADC is connected to the MCU.

6. A projector comprising:
a body;
a support shaft;
an input unit for receiving images;
a distance detection unit mounted on a front surface of the body, for detecting a distance between the distance detection unit and a light point on a screen by the distance detection unit;
an angle detection unit mounted in the support shaft, for detecting a projection angle of the body;
a micro controller unit, for obtaining a correction value according to the distance between the distance detection unit and the light point on the screen, and the projection angle of the body;
a graphics processing unit (GPU), for correcting the images from the input unit according to the correction value; and
an optical unit, for projecting the corrected images on the screen.

7. The projector of claim 6, wherein the MCU processes the distance between the distance detection unit and the light point on the screen, and the projection angle of the body to obtain a throw distance between the distance detection unit and the screen, the MCU further processes the throw distance and the projection angle of the body to obtain the correction value.

8. The projector of claim 7, wherein the distance detection unit is an infrared telemeter.

9. The projector of claim 7, wherein the throw distance between the distance detection unit and the screen equals to a product of the distance between the distance detection unit and the light point on the screen and a cosine of the projection angle of the body.

10. The projector of claim 6, wherein the angle detection unit includes a rheostat, a resistor, and an analog-to-digital converter (ADC), a slide terminal of the rheostat is connected to the support shaft of the projector, a first terminal of the rheostat is connected to a first power supply, a second terminal of the rheostat is grounded through the resistor, a node between the rheostat and the resistor is connected to an input of the ADC, an output of the ADC is connected to the MCU.
